(19) United States
(12) Patent Application Publication
(10) Pub. No.: US 2015/0209998 A1
(43) Pub. Date: Jul. 30, 2015

(54) SYSTEM AND METHODS FOR PREHEATING TWO STAGE PREFORMS

(71) Applicant: GOJO Industries, Inc., Akron, OH (US)

(72) Inventor: Eugene W. Ray, Barberton, OH (US)

(21) Appl. No.: 14/607,837

(22) Filed: Jan. 28, 2015

Related U.S. Application Data
(60) Provisional application No. 61/932,624, filed on Jan. 28, 2014.

(51) Int. Cl. B29C 49/64; H05B 3/00

(52) U.S. Cl. CPC B29C 49/6436; B29C 49/6418; H05B 3/0057; B29K 2105/258

(57) ABSTRACT

Exemplary methods and apparatuses for heating preforms are disclosed herein. An exemplary apparatus for heating a preform includes a gripping portion for gripping a preform. In addition, a heat shield portion configured to extend up into a preform above the base is also included, wherein the heat shield portion limits transfer of radiant heat through at least a portion of the interior of the preform to at least a portion of the back of the preform

### RELATED APPLICATIONS

This application claims priority to and the benefits of U.S. Provisional Patent Application Ser. No. 61/932,624 filed on Jan. 28, 2014 and entitled “SYSTEM AND METHODS FOR PREHEATING TWO STAGE PREFORMS,” which is incorporated herein by reference in its entirety.

### TECHNICAL FIELD

The present invention relates generally injection stretch blow molding and more particularly to improved preferential heating of two stage preforms.

### BACKGROUND OF THE INVENTION

Blow molding is used in manufacturing hollow articles, such as, for example, bottles and containers from various plastics and resins, such as, for example, polyethylene, polyvinyl chloride, polyacrylonitrile, polyethylene terephthalate (PET) and the like.

Reheat blow molding involves heating a preform, which was previously injection molded, to a suitable temperature and then blowing the preform into a finished product. The temperature is selected to provide biaxial orientation of the end product.

An advancement in blow molding technology utilizes preferential heating of two stage preforms that are used in the production of two-stage injection stretch blow molding (“ISBM”) of bottles and containers. The preferential heating utilizes heat lamps and reflectors (not shown). Heat energy from the lamps is directed at a preform which rotates at a known revolutions per minute (“RPM”) and travels down a conveyer at a known rate of speed. By turning on and off the heat lamps, or adjusting their intensity as the preform rotates, a user can selectively heat or cool parts of a preform in order to aid material distribution when the bottle or container is blown. This method is used to selectively add or remove thickness from a given point on a bottle.

A limitation to the current preferential heating is that as the preform spins through the section of equipment containing the heat lamps, the radiant heat energy passes through clear, material, such as, for example, a PET preform and heats the rear portion of the preform.

FIG. 1 illustrates a prior art system 100. Prior art system 100 includes a spindle 110. Spindle 110 includes an annular preform retention mechanism 112. Preform 102 includes a base 104 that is not preheated for the blow molding. Also illustrated in FIG. 1 is an array of heat lamps 120. Heat lamps 120 output radiant heat 122. As illustrated in FIG. 2, the spindle 110 rotates in direction 206. When the heat lamps 120 are energized, radiant heat 122 passes through the front of the preform 102 and continues to the back of the preform 102. Thus, the radiant heat 122 heats the front wall of the preform 102, and to a lesser extent, also heats the back wall of the preform 102. Such unintentional heating of the back wall of the preform 102 may make it difficult to form such types of containers.

### SUMMARY

Exemplary methods and apparatuses for heating preforms are disclosed herein. An exemplary apparatus for heating a preform includes a gripping portion for gripping a preform. In addition, a heat shield portion configured to extend up into a preform above the base is also included. The heat shield portion limits transfer of radiant heat through at least a portion of the interior of the preform to at least a portion of the back of the preform.

An exemplary method of heating a preform includes inserting a spindle having a gripping portion and a heat shield portion into the preform. Heating the preform with one or more heat lamps on a first side of the preform. Rotating the spindle and preform. The heat shield limits at least a portion of radiant heat from the heat lamps from passing through a first side of the preform to the interior of second side of the preform.

Another exemplary apparatus for heating a preform includes a plurality of heat lamps, a spindle having a gripping portion for gripping a preform, a rotator for rotating the spindle, and a heat shield portion that extends up into a preform above the gripping portion. Wherein the heat shield limits transfer of heat through a front wall of the preform, the interior of the preform and to the interior of at least a portion of a back wall of the preform.

### BRIEF DESCRIPTION OF THE DRAWINGS

These and other features and advantages of the present invention will become better understood with regard to the following description and accompanying drawings in which:

FIG. 1 is a partial cross-sectional view of a prior art system including a spindle for holding a preform and heat lamps for heating the preform;

FIG. 2 illustrates heating of the preform with radiant heat passing through the preform and heating the back side of the preform;

FIG. 3 illustrates an exemplary embodiment of a spindle having a heat shield;

FIG. 4 illustrates heating of the preform with at least a portion of the radiant heat being blocked from passing through the preform and heating the back side of the preform; and

FIG. 5 illustrates another exemplary embodiment of a spindle having a heat shield.

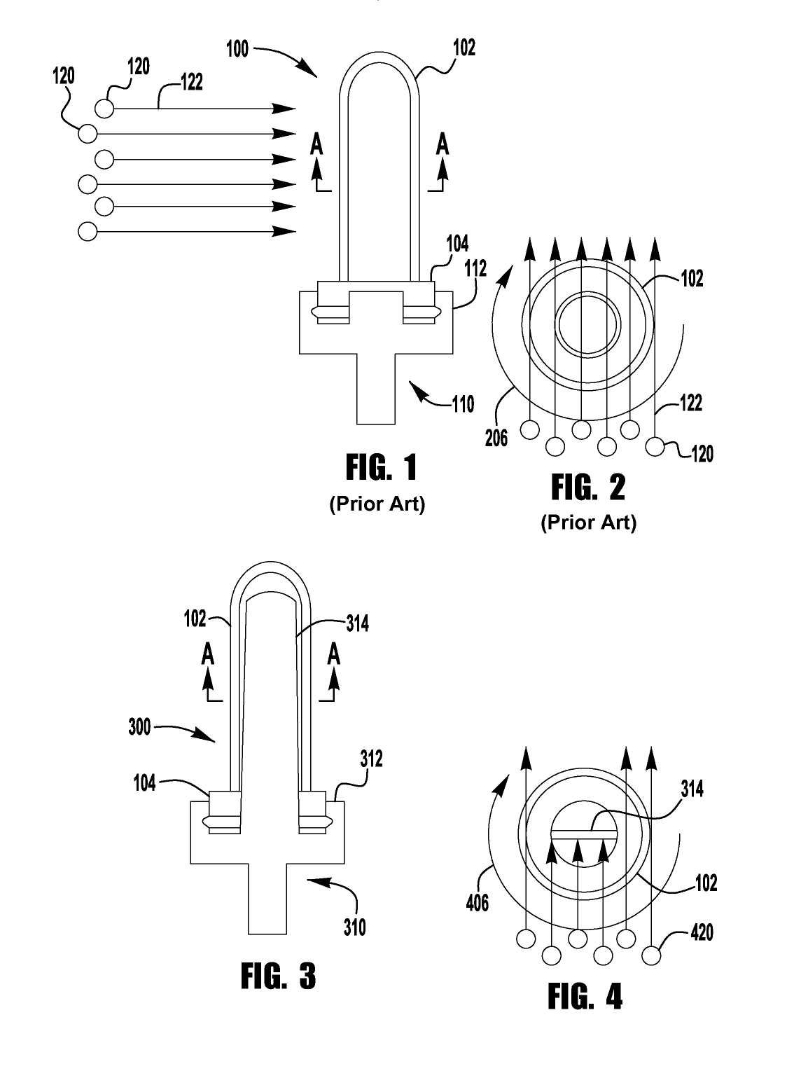

### DETAILED DESCRIPTION

FIGS. 3 illustrates an exemplary embodiment of a spindle 310 having a heat shield 315 that extends up into preform 102. The spindle 310 includes a gripping portion 104 that grips a base 104 of the preform 102. The base 104 is typically not heated to a temperature suitable for blow molding of the base 104. Heat shield 314 may have any shape, such as, for example, a rectangular cross-section as illustrated, a circular cross-section, and x-shaped cross section or the like depending on the desired heat distribution. Heat shield 314 may have multiple cross-sectional shapes or cross-sectional areas at different levels of the heat shield 414.

In addition, one or more edges of heat shield 314 may be contoured. As illustrated in FIG. 4, heat from heat lamps 420 pass through the front of preform 102 but do not reach the back of the preform 102 because they are blocked by heat shield portion 314.

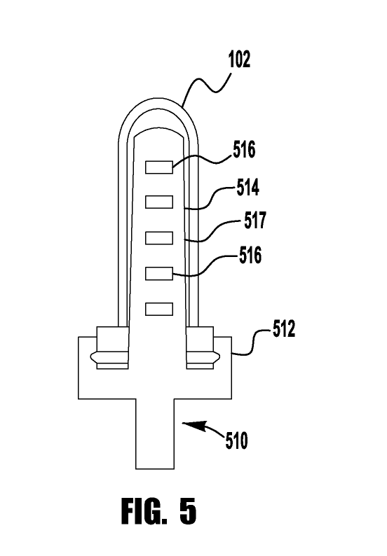

FIG. 5 illustrates another exemplary embodiment of a spindle 510 with a preform 102 secured to the spindle 510. Spindle 510 includes a gripping portion 512 that grips the base of preform 102 and a heat shield portion 514. Heat shield portion 514 extends up into the body of preform 102.

Heat shield portion 514 includes a plurality of cutouts 516. Cutouts 516 allow radiant heat to pass from the front side of preform 102 to the back side of preform 102 in selected areas. Heat shield portion 514 may have any cross-sectional shape, such as, for example, rectangular, cross, circular and the like. Heat shield 516 may have multiple cross-sectional shapes or cross-sectional areas at different levels of the heat shield 514. In addition, cutouts 516 may have any shape and need not be uniform. For example, the cutouts 516 may be concentrated on the top, bottom or middle of heat shield portion 514. A single cutout or multiple cutouts may be used. In addition, one or more edges of heat shield 516 may be contoured or shaped. Still yet, in some embodiments, the heat shield may be opaque and allow some of the radiant heat to pass through to the back side of the preform 102.

While the present invention has been illustrated by the description of embodiments thereof and while the embodiments have been described in considerable detail, it is not the intention of the applicant to restrict or in any way limit the scope of the appended claims to such detail. Additional advantages and modifications will readily appear to those skilled in the art. Therefore, the invention, in its broader aspects, is not limited to the specific details, the representative apparatus and illustrative examples shown and described. Accordingly, departures may be made from such details without departing from the spirit or scope of the applicant's general inventive concept.

I/we claim:

1. An apparatus for heating a preform comprising:
a gripping portion for gripping a preform;
a heat shield portion configured to extend up into a preform above the base; and
wherein the heat shield portion limits transfer of radiant heat through at least a portion of the interior of the preform to at least a portion of the back side of the preform.

2. The apparatus of claim 1 wherein the gripping portion and the heat shield portion are part of a spindle.

3. The apparatus of claim 1 wherein the heat shield portion is a solid surface.

4. The apparatus of claim 1 wherein the heat shield portion includes one or more cutouts.

5. The apparatus of claim 1 wherein the heat shield portion extends along a substantial length of a preform.

6. The apparatus of claim 1 wherein the heat shield has a planer configuration.

7. The apparatus of claim 1 wherein the heat shield has a circular cross-section.

8. The apparatus of claim 1 wherein at least a portion of the heat shield is contoured.

9. A method of heating a preform comprising:
inserting a spindle having a gripping portion and a heat shield portion into the preform;
heating the preform with one or more heat lamps on a first side of the preform;
rotating the spindle and preform;
wherein the heat shield limits at least a portion of radiant heat from the heat lamps from passing through a first side of the preform to the interior of second side of the preform.

10. The method of claim 9 further comprising heating a first portion of the preform to a temperature that is higher than a second portion of the preform.

11. The method of claim 9 further comprising removing the heat shield from the preform.

12. An apparatus for heating a preform comprising:
a plurality of heat lamps on a first side;
a spindle having a gripping portion for gripping a preform;
a rotator for rotating the spindle; and
a heat shield portion configured to extend up into a preform above the gripping portion;
wherein the heat shield limits transfer of heat through a first side of the preform, the interior of the preform and to the interior of at least a portion of a second side of the preform.

13. The apparatus of claim 12 wherein the heat shield portion is a solid surface.

14. The apparatus of claim 12 wherein the heat shield portion includes a plurality of cutouts.

15. The apparatus of claim 12 wherein the heat shield portion extends along a substantial length of a preform.

16. The apparatus of claim 12 wherein the heat shield has a planer configuration.

17. The apparatus of claim 12 wherein the heat shield has a circular cross-section.

18. The apparatus of claim 12 wherein the heat shield has a cross-shaped cross-section.

19. The apparatus of claim 12 wherein the heat shield is opaque and reduces the heat transferred through the interior of the preform.

20. The apparatus of claim 12 wherein at least a portion of the heat shield is contoured.
